(19) United States
(12) Patent Application Publication
(10) Pub. No.: US 2026/0050492 A1
(43) Pub. Date: Feb. 19, 2026

(54) DYNAMIC SERVICE MIGRATIONS FOR COMPOSABLE SYSTEMS

(71) Applicant: RED HAT, INC., Raleigh, NC (US)

(72) Inventors: Leigh Griffin, Waterford (IE); Adam O'Brien, Waterford (IE)

(21) Appl. No.: 18/807,289

(22) Filed: Aug. 16, 2024

(51) Int. Cl. G06F 9/50

(52) U.S. Cl. CPC G06F 9/5088

(57) ABSTRACT

Some examples of the present disclosure relate to dynamic service deployments for composable systems. In one particular example, a system can detect a change to a set of capabilities of nodes. The system can determine, in response to detecting the change, a resource requirement for a service being deployed using the nodes. The system can determine an upper value and a lower value defining a range of resource amounts for a node that is to execute the service based on the resource requirement. The system can select a first node for executing the service based on the first node having a first resource amount within the range of resource amounts. The system can cause an action associated with executing the service using the first node in response to selecting the first node.

### TECHNICAL FIELD

The present disclosure relates generally to software execution. More specifically, but not by way of limitation, this disclosure relates to migrating services for composable systems.

### BACKGROUND

Distributed computing systems (e.g., cloud computing systems, data grids, and computing clusters) have recently grown in popularity given their ability to improve flexibility, responsiveness, and speed over conventional computing systems. In some cases, the responsiveness and speed of distributed computing systems can be further improved by employing edge-computing solutions. Edge computing is a networking philosophy focused on bringing computing power and data storage as close to the source of the data as possible to reduce latency and bandwidth usage. Distributed computing environments may employ edge devices to perform various functions at the edge. Edge devices may be resource constrained and geographically isolated.

### BRIEF DESCRIPTION OF THE DRAWINGS

FIG. 1 is a block diagram of an example of a system for dynamic service migrations for composable systems according to some examples of the present disclosure.

FIG. 2 is a block diagram of an example of a computing environment for dynamic service migrations for composable systems according to some examples of the present disclosure.

FIG. 3 is a flow chart of an example of a process for dynamic service migrations for composable systems according to some examples of the present disclosure.

### DETAILED DESCRIPTION

Traditional hardware deployments, which may be cloud-based or Internet of Things (IoT), face inefficiencies when handling dynamic changes in their infrastructure. Dynamic changes can refer to a device or other hardware component joining or leaving the environment. Conventionally, any changes involve manual intervention, leading to resource under-utilization, over-provisioning, and potential service interruptions.

Some examples of the present disclosure can overcome one or more of the abovementioned problems by providing a system that can migrate services or composable systems. Composable systems are systems with components that can be selected and assembled in various combinations to satisfy specific desires. In an example, a system can detect a change to a set of capabilities (e.g., memory, processing, bandwidth, network, etc.) of nodes. The system can determine, in response to detecting the change, a resource requirement for a service being deployed using the nodes. The system can determine an upper value and a lower value defining a range of resource amounts for a node that is to execute the service based on the resource requirement. The system can select a first node for executing the service based on the first node having a first resource amount within the range of resource amounts. The system can cause an action associated with executing the service using the first node in response to selecting the first node. So, resources are utilized or allocated in a manner such that devices or nodes are not over-utilized or under-utilized for a given service. As composable systems present the ability to rapidly and flexibly change the computational landscape, the ability to adapt services in response to the environment changing becomes possible. As a result, overall performance of the nodes and the system are improved.

As a particular example, a computing environment can include two nodes. A first node can include fifty Megabytes (MB) of random access memory (RAM) and a second node can include thirty MB of RAM. The second node is executing a software application. A system detects that thirty MB of RAM are added to the second node, resulting in the second node having sixty MB of RAM. The system then determines that the software application has a resource requirement of forty MB of RAM and defines a range of resource amounts for a node executing the software application to be between thirty MB of RAM and fifty MB of RAM. Since the second node is now overprovisioned for the software application and is under-utilized when executing the software application, the system migrates the software application to the first node that has the amount of RAM within the range of resource amounts. As such, a node of appropriate capability executes the software application, leading to efficient resource utilization.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

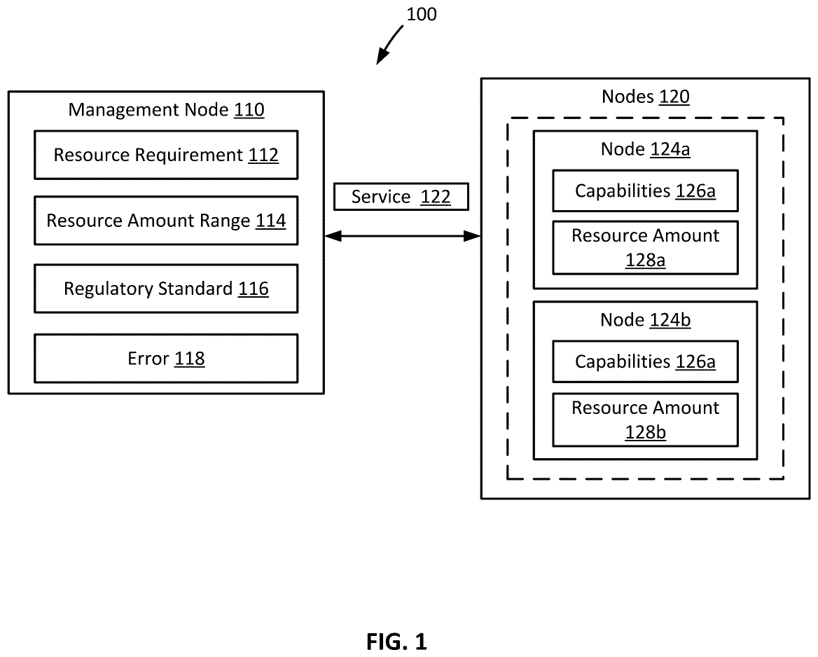

FIG. 1 is a block diagram of an example of a system 100 for dynamic service migrations for composable systems according to some examples of the present disclosure. In some examples, the system 100 may be a distributed computing environment such as an edge computing environment, a cloud computing environment, or a computing cluster. The system 100 may alternatively be a physical data center. The system 100 can be formed from a management node 110 and one or more nodes 120 (e.g., physical servers, virtual servers, Internet of Things (IoT) devices, etc.) that are in communication with one another via a network, such as a local area network (LAN), wide area network (WAN), the Internet, or any combination thereof.

The system 100 can include the management node 110 that can manage or otherwise communicate with nodes 120. Examples of the management node 110 or of the nodes 120 can include desktop computers, laptop computers, servers, mobile phones, tablets, etc. The nodes 120 may be edge devices such as Raspberry Pis, sensors, or other resource-constrained, IoT devices. As illustrated, the nodes 120 include node 124a and node 124b.

The management node 110 can determine a change to a set of capabilities of the nodes 120. The set of capabilities can correspond to capabilities 126a-126b, where capabilities 126a are capabilities of the node 124a and the capabilities 126b are capabilities of the node 124b. The set of capabilities may be a hardware component or a resource amount for the nodes 120. For instance, the change may correspond to an addition or removal of a memory device, an addition or removal of processing device, an addition or removal of a persistent volume, a change to network bandwidth, an addition or removal of a network interface, or any other suitable change. The management node 110 may periodically poll the nodes 120 to determine when the change occurs. Alternatively, when a change occurs to a node, the given node may notify the management node 110 of the change.

In some examples, the management node 110 may determine a resource requirement 112 for a service 122 being deployed using the nodes 120 in response to the change. The resource requirement 112 may be a memory usage, a central processing unit (CPU) usage, a bandwidth requirement, a network requirement, etc. for the service 122. The management node 110 may determine the resource requirement 112 from metadata and a configuration file associated with the service 122. In addition, the management node 110 may determine resource requirements for other services that are also being deployed using the nodes 120. So, the management node 110 can determine the current state of computational load and hardware requirements for the system 100.

Upon determining the resource requirement 112 for the service 122, the management node 110 can define a resource amount range 114 for a node of the nodes 120 that is to execute the service 122 based on the resource requirement 112. The resource amount range 114 can include an upper value and a lower value of resource amounts that a node can have for executing the service 122. For example, the resource amount range 114 for a memory device may be between one and 1.5 megabytes (MB) if the resource requirement 112 for the service 122 is 1.25 Mb.

In some examples, the management node 110 can select a node of the nodes 120 for executing the service 122 based on the node having a resource amount within the resource amount range 114. For example, the management node 110 can evaluate resource amounts 128a-128b of the nodes 124a-124b and determine that the resource amount 128a is within the resource amount range 114 and that the resource amount 128b is outside of the resource amount range 114. For each resource (e.g., memory, CPU, network, etc.), the resource amount 128a may be within the resource amount range 114. Alternatively, each resource may be assigned a priority and only the highest priority resource may need to have the resource amount 128a within the resource amount range 114. In any case, upon determining that the resource amount 128a for the node 124a is within the resource amount range 114, the management node 110 can select the node 124a for executing the service 122. Since the resource amount range 114 is based on the resource requirement 112 for the service 122, the node 124a is a “right size” node for the service 122. This means that resources of the node 124a are not under-utilized or over-utilized when executing the service 122. The node 124a is provisioned appropriately for the service 122.

Once the management node 110 selects the node 124a for executing the service 122, the management node 110 can cause an action associated with executing the service 122 using the node 124a. For example, the action may involve migrating the service 122 from another node (e.g., node 124b) to the node 124a based on the other node having the resource amount 128b that is outside the resource amount range 114. As such, the deployment of the service 122 is dynamically adjusted based on the changing computational landscape of the system 100. Or, the action may involve instantiating an instance of the service 122 on the node 124a while executing another instance of the service 122 on another node of the nodes 124a. The instantiation may take advantage of added resources. For instance, if memory is added to the node 124a as part of the change that causes the node 124a to have the resource amount 128a that is within the resource amount range 114, the management node 110 can instantiate an instance of the service 122 on the node 124a to take advantage of the added memory.

In some examples, the management node 110 may determine that the service 122 is executing on the node 124a prior to the change. The change may result in the resource amount 128a no longer being within the resource amount range 114. So, in response to determining the resource amount range 114, the management node 110 can reallocate a resource to the node 124a to meet the resource amount range 114. For example, the management node 110 may reallocate memory to the node 124a if the process of reallocating the memory consumes fewer resources than migrating the service 122 to a different node. The management node 110 can then select the node 124a for executing the service 122 based on the resource amount 128a with the reallocated resource being within the resource amount range 114. As a result, the action can involve maintaining the service 122 on the node 124a.

In some embodiments, multiple nodes may have a resource amount that is within the resource amount range 114. For example, both of the nodes 124a-124b may have the resource amounts 128a-128b that are within the resource amount range 114. To determine which node to select, the management node 110 can compare the nodes 124a-124b to a regulatory standard 116. That is, prior to redeployment of the service 122, redeployment options can be checked against the regulatory standard 116 that can govern where the service 122 can be deployed and where its data needs to be located to ensure compliance with the regulatory standard 116. The regulatory standard 116 may be a general data protection regulation (GDPR) standard, a health insurance portability and accountability act (HIPAA) standard, a payment card industry data security standard (PCI DSS), and the like. The management node 110 may determine that the node 124a meets the regulatory standard 116, while the node 124b does not meet the regulatory standard 116. So, the management node 110 can select the node 124a for executing the service 122 based on the node 124a meeting the regulatory standard 116.

In some examples, the management node 110 can learn from each adjustment that is made in response to changes to the capabilities of the nodes 120. For example, the management node 110 may determine that the service 122 needs an additional one MB of storage for the resource requirement 112. The management node 110 defines the resource amount range 114 based on the resource requirement 112 and selects a node based on the resource amounts for the nodes 120 resource amount range 114. The management node 110 then causes the action associated with executing the service using the selected node, where the action can involve migrating the service 122 to a different node. If the resource requirement 112 then changes to no longer needing the one MB of storage, the management node 110 can determine whether to migrate the service 122 again (e.g., back to the original node) or not. For instance, the management node 110 may determine that the computational effort of moving the service 122 outweighs having the one MB of extra storage, so the management node 110 maintains the service 122 on the new node. But, if the change in the resource requirement 112 is larger (e.g., one Gigabyte), then the management node 110 may proceed with migrating the service 122 again.

The management node 110 can additionally learn and adjust a window during which to evaluate changes to the capabilities and cause actions. For example, the management node 110 can cause the action within a first time period (e.g., ten seconds) of detecting the change. To account for possible temporary errors, such as a power outage, the management node 110 can determine an update from the first time period to a second time period (e.g., one minute) for causing subsequent actions for subsequent changed to the capabilities. So, upon detecting another change to the capabilities of the nodes 120, the management node 110 can select a node for executing the service 122 based on the node having a resource amount within the resource amount range 114 subsequent to the second time period passing.

In some examples, the management node 110 can also handle failover for detected failures. For instance, subsequent to causing the action, the management node 110 may detect an error 118 associated with the node (e.g., node 124a) executing the service 122. The error 118 may involve the node 124a being corrupted, being offline, being unresponsive, etc. In response to detecting the error 118, the management node 110 can migrate the service 122 from the node 124a to a closest node (e.g., node 124b) prior to reevaluating the nodes 120 for meeting the resource amount range 114. Once the service 122 is migrated from the node 124a, the management node 110 can then determine where to move the service 122 or how to right-size (e.g., add or remove resources) based on the resource amount range 114. As such, the management node 110 can efficiently handle errors to continue execution of services.

While FIG. 1 depicts a specific arrangement of components, other examples can include more components, fewer components, different components, or a different arrangement of the components shown in FIG. 1. For instance, while FIG. 1 only shows two nodes, other examples may include a different number of nodes. Also, any component or combination of components depicted in FIG. 1 can be used to implement the process(es) described herein.

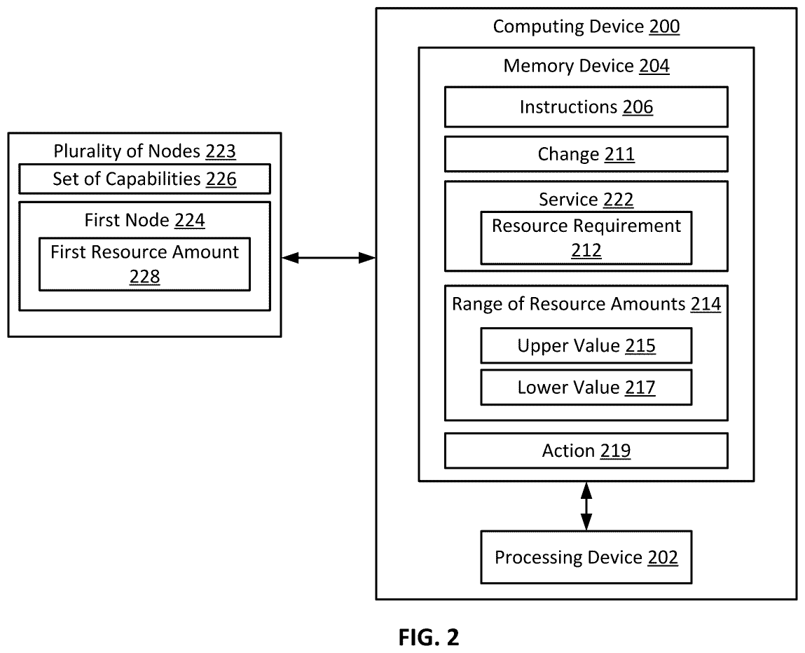

FIG. 2 is a block diagram of an example of a computing device for dynamic service migrations for composable systems according to some examples of the present disclosure. The computing device 200 includes a processing device 202 communicatively coupled to a memory device 204. In some examples, the components of the computing device 200, such as the processing device 202 and the memory device 204, may be part of a same computing device, such as the management node 110 in FIG. 1. In other examples, the processing device 202 and the memory device 204 can be included in separate computing devices that are communicatively coupled.

The processing device 202 can include one processing device or multiple processing devices. Non-limiting examples of the processing device 202 can include a Field-Programmable Gate Array (FPGA), an application-specific integrated circuit (ASIC), and a microprocessor. The processing device 202 can execute instructions 206 stored in the memory device 204 to perform computing operations. In some examples, the instructions 206 can include processor-specific instructions generated by a compiler or an interpreter from code written in any suitable computer-programming language, such as C, C++, C#, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory device 204 can include a non-transitory computer-readable medium from which the processing device 202 can read instructions 206. A computer-readable medium can include electronic, optical, magnetic, or other storage devices capable of providing the processing device 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

In some examples, the processing device 202 can execute the instructions 206 to perform some or all of the functionality described herein. For example, the processing device 202 can detect a change 211 to a set of capabilities 226 of a plurality of nodes 223. The processing device 202 can determine, in response to detecting the change 211, a resource requirement 212 for a service 222 being deployed using the plurality of nodes 223. The processing device 202 can determine an upper value 215 and a lower value 217 defining a range of resource amounts 214 for a node of the plurality of nodes 223 that is to execute the service 222 based on the resource requirement 212. The processing device 202 can select a first node 224 of the plurality of nodes 223 for executing the service 222 based on the first node 224 having a first resource amount 228 within the range of resource amounts 214. The processing device 202 can cause an action 219 associated with executing the service 222 using the first node 224 in response to selecting the first node 224. The action 219 may involve reallocating a resource to the first node 224, migrating the service 222 from a second node of the plurality of nodes 223, or instantiating an instance of the service 222 on the first node 224 while executing another instance of the service 222 on another node. As such, as changes are made to the set of capabilities 226, services are dynamically migrated and nodes are reprovisioned so that services execute on nodes that are not over or under loaded, resulting in improved performance.

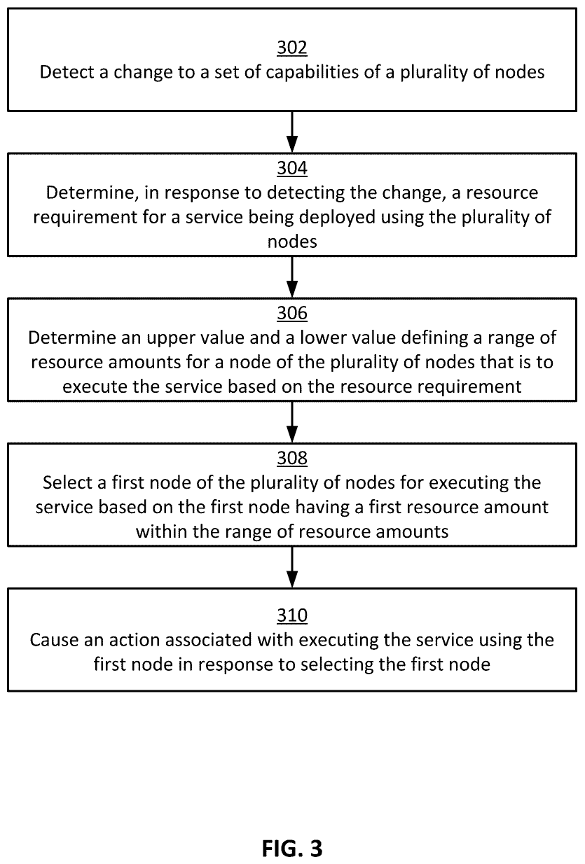

FIG. 3 is a flow chart of an example of a process for dynamic service migrations for composable systems according to some examples of the present disclosure. In some examples, the processing device 202 can implement some or all of the steps shown in FIG. 3. Additionally, in some examples, the processing device 202 can be executing on or in communication with the management node 110 of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can detect a change 211 to a set of capabilities 226 of a plurality of nodes 223. The set of capabilities 226 include hardware components (e.g., virtual or physical) or a resource amount for the plurality of nodes 223. For instance, the change 211 may be a change to an amount of memory, a change to a processing device, a change to a persistent volume, a change to network bandwidth, a change to a network interface, etc. The processing device 202 can detect the change 211 by polling the plurality of nodes 223 to determine when the change 211 occurs. Alternatively, when a change occurs to a node, the given node may notify the processing device 202 of the change 211.

At block 304, the processing device 202 can determine, in response to detecting the change 211, a resource requirement 212 for a service 222 being deployed using the plurality of nodes 223. The resource requirement 212 may be a memory usage, a CPU usage, a bandwidth requirement, a network requirement, etc. for the service 222. The processing device 202 can inspect a configuration file of the service 222 to determine the resource requirement 212.

At block 306, the processing device 202 can determine an upper value 215 and a lower value 217 defining a range of resource amounts 214 for a node of the plurality of nodes 223 that is to execute the service 222 based on the resource requirement 212. The range of resource amounts 214 can be based on the resource requirement 212. For instance, a defined amount greater than the resource requirement 212 may be the upper value 215 and a defined amount less than the resource requirement 212 may be the lower value 217. The defined amounts may be based on the type of resource (e.g., memory, bandwidth, CPU, etc.).

At block 308, the processing device 202 can select a first node 224 of the plurality of nodes 223 for executing the service 222 based on the first node 224 having a first resource amount 228 within the range of resource amounts 214. The processing device 202 can evaluate the first resource amount 228 and resource amounts of other nodes of the plurality of nodes 223 and determine that the first resource amount 228 is within the range of resource amounts 214. The processing device 202 can also determine that the other resource are outside of the range of resource amounts 214. So, the processing device 202 can select the first node 224 for executing the service 222 since resources of the first node 224 are not under-utilized or over-utilized when executing the service 222. In some instances, the selection may also involve a comparison to a regulatory standard and selecting a node that meets the regulatory standard.

At block 310, the processing device 202 can cause an action 219 associated with executing the service 222 using the first node 224 in response to selecting the first node 224. The action 219 may involve reallocating a resource to the first node 224, migrating the service 222 from a second node of the plurality of nodes 223, or instantiating an instance of the service 222 on the first node 224 while executing another instance of the service 222 on another node.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device including instructions that are executable by the processing device for causing the processing device to perform operations comprising:
detecting a change to a set of capabilities of a plurality of nodes;
determining, in response to detecting the change, a resource requirement for a service being deployed using the plurality of nodes;
determining an upper value and a lower value defining a range of resource amounts for a node of the plurality of nodes that is to execute the service based on the resource requirement;
selecting a first node of the plurality of nodes for executing the service based on the first node having a first resource amount within the range of resource amounts; and
causing an action associated with executing the service using the first node in response to selecting the first node.

2. The system of claim 1, wherein the operations further comprise:
determining that the service is executing on the first node prior to the change; and
reallocating a resource to the first node to meet the range of resource amounts for the first node, wherein the causing the action comprises maintaining the service on the first node.

3. The system of claim 1, wherein causing the action comprises:
migrating the service from a second node of the plurality of nodes to the first node based on the second node having a second resource amount outside of the range of resource amounts.

4. The system of claim 1, wherein causing the action comprises:
instantiating a first instance of the service on the first node while executing a second instance of the service on a second node of the plurality of nodes.

5. The system of claim 1, wherein the change is a first change and wherein the operations further comprise:
causing the action within a first time period of detecting the first change;
determining an update from the first time period to a second time period for causing subsequent actions for subsequent changes to the set of capabilities;
detecting a second change to the set of capabilities of the plurality of nodes; and
selecting, in response to detecting the change and subsequent to the second time period passing, a second node of the plurality of nodes for executing the service based on the second node having a second resource amount within the range of resource amounts.

6. The system of claim 1, wherein the operations further comprise:
determining that the first node has the first resource amount within the range of resource amounts and that a second node of the plurality of nodes has a second resource amount within the range of resource amounts;
comparing that the first node and the second node to a regulatory standard; and
selecting the first node based on the first node meeting the regulatory standard and the second node not meeting the regulatory standard.

7. The system of claim 1, wherein the operations further comprise:
subsequent to causing the action, detecting an error associated with the first node; and
migrating the service from the first node to a second node of the plurality of nodes prior to reevaluating the plurality of nodes for meeting the range of resource amounts.

8. A method comprising:
detecting a change to a set of capabilities of a plurality of nodes;
determining, in response to detecting the change, a resource requirement for a service being deployed using the plurality of nodes;
determining an upper value and a lower value defining a range of resource amounts for a node of the plurality of nodes that is to execute the service based on the resource requirement;
selecting a first node of the plurality of nodes for executing the service based on the first node having a first resource amount within the range of resource amounts; and
causing an action associated with executing the service using the first node in response to selecting the first node.

9. The method of claim 8, further comprising:
determining that the service is executing on the first node prior to the change; and
reallocating a resource to the first node to meet the range of resource amounts for the first node, wherein the causing the action comprises maintaining the service on the first node.

10. The method of claim 8, wherein causing the action comprises:
migrating the service from a second node of the plurality of nodes to the first node based on the second node having a second resource amount outside of the range of resource amounts.

11. The method of claim 8, further comprising:
instantiating a first instance of the service on the first node while executing a second instance of the service on a second node of the plurality of nodes.

12. The method of claim 8, wherein the change is a first change and wherein the method further comprises:
causing the action within a first time period of detecting the first change;
determining an update from the first time period to a second time period for causing subsequent actions for subsequent changes to the set of capabilities;
detecting a second change to the set of capabilities of the plurality of nodes; and
selecting, in response to detecting the change and subsequent to the second time period passing, a second node of the plurality of nodes for executing the service based on the second node having a second resource amount within the range of resource amounts.

13. The method of claim 8, further comprising:
determining that the first node has the first resource amount within the range of resource amounts and that a second node of the plurality of nodes has a second resource amount within the range of resource amounts;
comparing that the first node and the second node to a regulatory standard; and
selecting the first node based on the first node meeting the regulatory standard and the second node not meeting the regulatory standard.

14. The method of claim 8, further comprising:
subsequent to causing the action, detecting an error associated with the first node; and
migrating the service from the first node to a second node of the plurality of nodes prior to reevaluating the plurality of nodes for meeting the range of resource amounts.

15. A non-transitory computer-readable medium comprising program code that is executable by a processor for causing the processor to perform operations including:
detecting a change to a set of capabilities of a plurality of nodes;
determining, in response to detecting the change, a resource requirement for a service being deployed using the plurality of nodes;
determining an upper value and a lower value defining a range of resource amounts for a node of the plurality of nodes that is to execute the service based on the resource requirement;
selecting a first node of the plurality of nodes for executing the service based on the first node having a first resource amount within the range of resource amounts; and
causing an action associated with executing the service using the first node in response to selecting the first node.

16. The non-transitory computer-readable medium of claim 15, wherein the operations further comprise:
determining that the service is executing on the first node prior to the change; and
reallocating a resource to the first node to meet the range of resource amounts for the first node, wherein the causing the action comprises maintaining the service on the first node.

17. The non-transitory computer-readable medium of claim 15, wherein causing the action comprises:
migrating the service from a second node of the plurality of nodes to the first node based on the second node having a second resource amount outside of the range of resource amounts.

18. The non-transitory computer-readable medium of claim 15, wherein the operations further comprise:
instantiating a first instance of the service on the first node while executing a second instance of the service on a second node of the plurality of nodes.

19. The non-transitory computer-readable medium of claim 15, wherein the change is a first change and wherein the operations further comprise:
causing the action within a first time period of detecting the first change;
determining an update from the first time period to a second time period for causing subsequent actions for subsequent changes to the set of capabilities;
detecting a second change to the set of capabilities of the plurality of nodes; and
selecting, in response to detecting the change and subsequent to the second time period passing, a second node of the plurality of nodes for executing the service based on the second node having a second resource amount within the range of resource amounts.

20. The non-transitory computer-readable medium of claim 15, wherein the operations further comprise:
determining that the first node has the first resource amount within the range of resource amounts and that a second node of the plurality of nodes has a second resource amount within the range of resource amounts;
comparing that the first node and the second node to a regulatory standard; and
selecting the first node based on the first node meeting the regulatory standard and the second node not meeting the regulatory standard.
